(19) United States
(12) Patent Application Publication
(10) Pub. No.: US 2005/0149618 A1
(43) Pub. Date: Jul. 7, 2005

(54) System and method of transmitting electronic files over to a mobile phone

(75) Inventor: Jen-Po Cheng, Taipei (TW)

Correspondence Address: VENABLE LLP, P.O. BOX 34385, WASHINGTON, DC, 20435-9998, US

(73) Assignee: Mobile Action Technology Inc., Shindian City (TW)

(21) Appl. No.: 10/742,784

(22) Filed: Dec. 23, 2003

(51) Int. Cl. G06F 15/16

(52) U.S. Cl. 709/206; 709/219

(57) ABSTRACT

A method and system of transmitting electronic files over to a mobile phone is disclosed. The system introduces a personalized service by allowing the sender of an electronic file to add a personalized note to the WAP PUSH message, such that the receiver of the WAP PUSH message can be well informed of the motive and the identity of the sender behind the electronic file and use the routing information to retrieve the electronic file; and later the sender can receive a confirmation message from the network server after the receiver has successfully downloaded the electronic file. For the sender of electronic file, the personal message can be clearly expressed without causing any confusion for the receiver, which is largely lacking from current download services.

### BACKGROUND OF THE INVENTION

1. Field of the Invention

The present invention is related to a system and method of transmitting electronic files over to a mobile phone, in particular to a method of downloading files carrying melody ringers, motion pictures, pop songs, or Java® games to a mobile phone, and the related system.

2. Description of Related Art

The practice of using mobile phones with wireless applications protocols (WAP) to browse through web pages on the Internet and hypertext transfer protocols (HTTP) tools to find downloadable files of motion pictures, melody ringers, or Java games from specific web stations has been known for some time.

The standard operation procedures on a typical web station are as follows:

the sender (or subscriber) browses through the items on offer from the web server, which can be motion pictures, melody ringers, or Java games;

the sender selects specific items, and puts them into a virtual shopping cart;

the sender then enters the information of a designated receiver of electronic file, phone number of a mobile phone, and submits the form to the web server;

the web server then send a special short message service (SMS) message, called WAP PUSH message which is compliant with GSM format, to the receiver of the electronic file, which contains the routing information leading to the network server for fetching the above electronic file; and

the receiver over the mobile phone then follows the routing information leading to the destination to download the electronic file selected by the sender.

The standard procedures for downloading an electronic file are as follows:

1. Firstly, a business operator has to establish a web server loaded with electronic files carrying desirable motion pictures, melody ringers, or Java games, and at the same time the operator goes to apply for a fixed IP address from the telecommunications service provider in order to put the web server on the Internet service as a web station, whereby subscribers can browse to pick out from the list of items the operator has to offer for downloading;

2. a sender (or subscribers, who needs to be a registered member of the web station, logs in over a personal computer, and shops for favorite items such as motion pictures, melody ringers or games electronically; alternatively, the subscriber can call in through a mobile phone, house phone or toll phone to do the electronic shopping;

3. the sender of electronic file then enters the information of designated receiver of electronic file, such as model number and phone number of a mobile phone, and submits the form to the web server;

4. the web server then sends out a WAP PUSH message to the receiver's mobile-phone, which contains the routing information leading to the network server to fetch the selected electronic file; and

5. after receiving the WAP PUSH message, the receiver over the mobile phone follows the routing information to the destination to obtain the selected electronic file for downloading.

From the procedures described above, it is apparent that most operators of web stations still cannot provide senders of electronic file with personalized services, such as creating personalized note for the WAP PUSH MESSAGE receiver, as the commonly used standard message format makes no mention of vital personal information such as the identity of the actual sender of the electronic file, the content of what is being sent, and why it is being sent.

For example, party A, the sender of electronic file, has selected a motion picture from a web station, which is intended to be a birthday present for party B, the receiver of the electronic file. When party B receives an WAP PUSH message only containing the routing information leading to the destination where the motion picture file is saved, party B has no way of knowing who the sender of the electronic file is, nor the purpose of sending this WAP PUSH message. Thus this type of WAP PUSH message lacks the personal touch most people are expecting in a personal message. Furthermore, party A has no way of knowing whether party B has actually obtained the picture file from the download web station.

### SUMMARY OF THE INVENTION

The main object of the present invention is to provide a system and method of transmitting electronic files over to a mobile phone, whereby the sender of electronic files is able to put a personalized note in the WAP PUSH message.

The second object of the present invention is to provide a system and method of transmitting electronic files over a mobile phone, whereby the sender of the electronic file can obtain a confirmation message from the network server to find out whether the selected electronic file has been received by the designated receiver.

To this end, the method of transmitting electronic files over to a mobile phone comprises the steps of:

transmitting an text message containing a personalized note together with an attached electronic file to a specific network server;

saving the electronic file in the user disk of the network server;

generating a WAP PUSH message that contains the personalized note of the sender and the routing information leading to the network server where the selected electronic files are kept; and

forwarding the WAP PUSH message to the messenger of the service provider that will then relay this message to the mobile phone of the receiver of the electronic file; whereby

the receiver of the electronic file will be able to see the personalized note, after receiving the WAP PUSH message over the mobile phone, and the routing information of the network server to fetch the electronic file for downloading; and

the sender of the electronic file can receive a confirmation message from the network server when the sender checks with the network server to find out whether the receiver has actually obtained the selected electronic file.

The configuration of the required system for the present invention comprises:

a network server, which has a user disk, a download manager, and a communications manager that can issue WAP PUSH messages through the messenger service of the telecommunications service provider;

a base unit, through which the sender of the electronic file is able to create a personalized note in the WAP PUSH message and put a selected electronic file on the network server for downloading by a receiver, wherein the above network server generates a WAP PUSH message contains a personalized note of the sender and the routing information leading to the network server for downloading of the user's selected electronic file; whereby the sender can check over the base unit with the network server to find out whether the selected electronic file has been received by the receiver; and

a mobile unit, which is embedded with a mobile user interface for receiving WAP PUSH messages from the network server; whereby the receiver is able over the mobile phone to use the routing information contained in the WAP PUSH message to reach the network server for downloading the selected electronic file.

The switching system has a plurality of wireless applications protocol (WAP) gateways that receive instructions from the receiver's mobile phone and transmit the instruction to the network server for downloading the electronic file.

The base unit is embedded with a network user interface and an uplink driver, wherein the network user interface serves to maintain the bilateral communication between the base unit and the network server, and the uplink driver is used to make the necessary connection to the network server, both programs being resident in the computer of the base unit.

The present system is characterized in that the receiver of the electronic file can be well informed of the motive and the identity of the sender behind the electronic file and use the routing information to receive the electronic file.

The present system is also characterized in that the sender can receive a confirmation message from the network server after the receiver has successfully downloaded the electronic file, and also the personal note in the WAP PUSH message can help clear away any confusion the receiver may have, as well as adding a personal touch to the standard format of a short message.

Other objectives, advantages and novel features of the invention will become more apparent from the following detailed description when taken in conjunction with the accompanying drawings.

### BRIEF DESCRIPTION OF THE DRAWINGS

FIG. 1 is the system block diagram of the present invention; and

FIG. 2 is a flow chart of the standard operating procedures adopted by the present invention.

### DETAILED DESCRIPTION OF THE PREFERRED EMBODIMENT

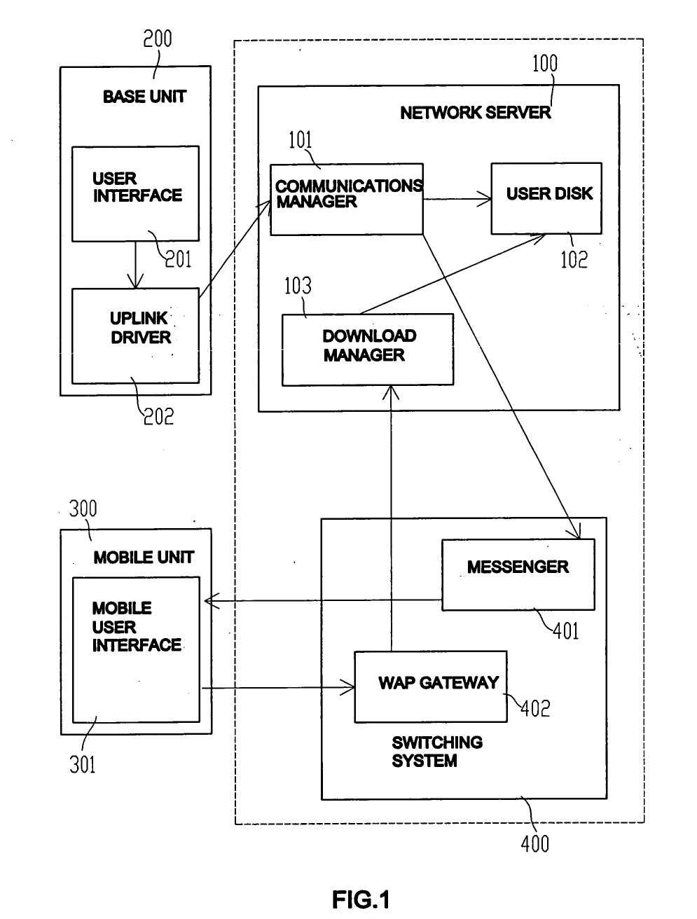

A system of transmitting electronic files over to a mobile phone, as shown in FIG. 1, comprises a network server (100), a base unit (200), and a mobile unit (300).

The network server (100) has a user disk (102), a download manager (103), and a communications manager (101) that is able to issue an WAP PUSH message to a messenger (401) of the service provider to establish a call link through the switching system (400).

The base unit (200) can be a personal computer or a personal digital assistant (PDA), embedded with a network user interface (201) and an uplink driver (202), wherein the network user interface (201) serves to maintain the bilateral communications between the base unit (200) and the network server (100), and the uplink driver (202) is responsible for establishing the network connection, wherein the network user interface (201) and the uplink driver (202) can be two independent programs or combined into one integrated software, while both programs are resident in the base unit (200).

The mobile unit (300) is embedded with a mobile user interface (301), a resident program in the mobile unit (300), which is used to receive WAP PUSH messages from the network server (100).

The above network server (100) is mainly responsible for maintaining data communications between the base unit (200) and the mobile unit (100) and transmitting the electronic file over to the mobile unit (100), wherein the network server (100) is formed by three components: a communications manager (101), a user disk (102) and a download manager (103), where these three components can be implemented as independent devices or can be incorporated into an integrated server.

The switching system (400) contains a messenger (401) and a plurality of wireless applications protocol (WAP) gateways (402) for establishing bi-directional communications with the mobile unit (300).

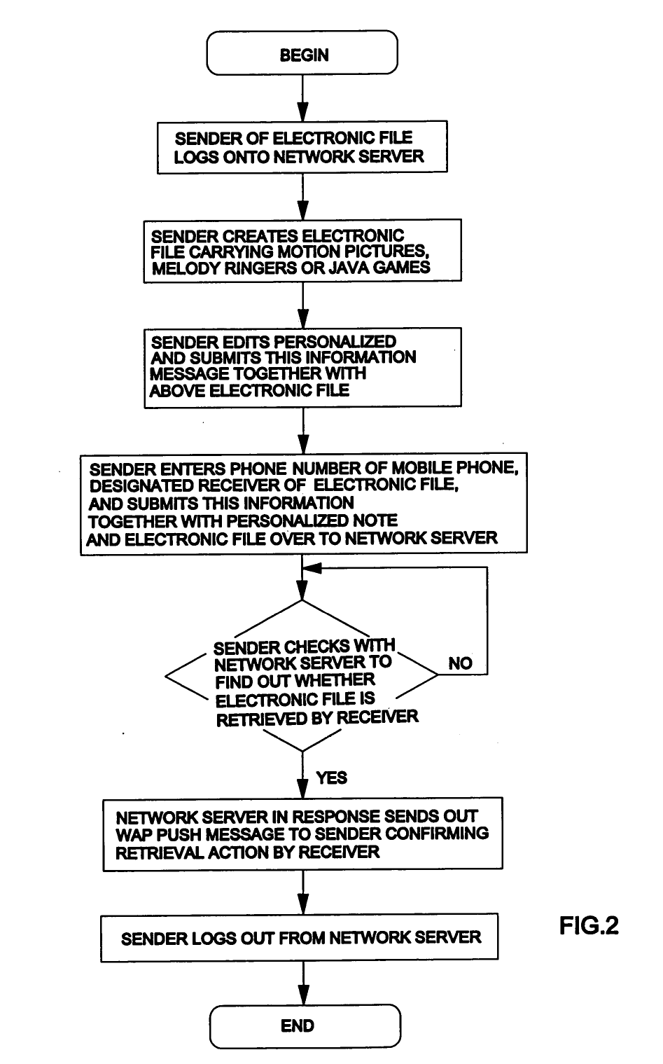

In actual application of the present system, as shown in FIG. 2, the sender of an electronic file over the base unit (200), through the network user interface (201), can create an electronic file in the data format of melody ringers, motion pictures, pop songs, or Java games, and create a personalized note to put in the WAP PUSH message that will be issued over a mobile unit (300) to the receiver of the message. The WAP PUSH message containing a personalized note, attached electronic file, and the phone number of the mobile unit (300) will be forwarded to the communications manager (101) of the network server (100) through the function of the uplink driver (202).

When the communications manager (101) has received the personalized note for the WAP PUSH message and the user has selected an electronic file from the base unit (200), the communications manager (101) initiates two procedures simultaneously: saving the user selected electronic file in the user disk (102), and issuing the WAP PUSH message, containing a personalized note and the routing information, to the receiver over the mobile unit (300) through the service of the messenger (401). Finally, the WAP PUSH message containing the personalized note and the routing information is received by the receiver of the electronic file who then enters the network server (100) to download the user selected electronic file thereafter.

The receiver can reach over the mobile unit (300) the destination disclosed in the routing information through the mobile user interface (301), with a call placed through the WAP gateway (402) of the switching system (400) to make the necessary connection to the download manager (103) on the network server (100), and thereafter the download manager (103) will retrieve the electronic file from the user disk (102) and dispatch it over the line connection to the receiver over the mobile unit (300). At the same time, the downloading of the electronic file will be timely recorded by the network server (100).

The sender of the electronic file over the base unit (200) through the resident uplink driver (202) can initiate a check with the network server (100) to find out whether the electronic file put onto the user's disk (102) has been retrieved by the receiver of electronic file. If the record on the network server (100) shows that the electronic file has been taken out by the receiver, a confirmation message will be issued through the uplink driver (202) to the sender of the electronic file informing of such action.

From the foregoing, the present invention has created an enhanced system for transferring and downloading files over a mobile phone by introducing a personalized service and greater interaction between the sender and the receiver of an electronic file. For example, the sender of the electronic file is allowed to create a personalized note for the WAP PUSH message, and the sender of the electronic file can receive a confirmation message from the network server after the receiver has successfully retrieved the selected electronic file from the network server.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

1. A method of transmitting electronic files over to a mobile phone, comprising the steps of:
creating a personalized note and attaching a selected electronic file by a sender of an electronic file working over a base unit (200);
forwarding the message, containing the personalized note and the electronic file, to a specific network server (100), where the network server (100) will generate a WAP PUSH message to be sent to a mobile unit (300), representing a designated receiver of the electronic file, which contains a personalized note and routing information leading to the network server (100) for downloading of a selected electronic file;
sending the WAP PUSH message by the network server (100) to the receiver of the electronic file over the mobile unit (300) through messenger (401) of the service provider;
whereby, after receiving the WAP PUSH message, the receiver of the electronic file over the mobile unit (300) is able to read the personalized note created by the sender of electronic file and then use the routing information to find the network server (100) where the electronic file is kept for downloading.

2. The method of transmitting electronic files over to a mobile phone as claimed in claim 1, wherein the downloading of the electronic file by the mobile unit (300) is timely recorded by the download manager (103) of the network server (100), whereby the sender of the electronic file can check with the network server (100) to find out whether the selected electronic file has been retrieved by the receiver.

3. A system of transmitting electronic files over to a mobile phone, comprising:
a network server (100), which has a user disk (102) responsible for keeping an electronic file selected by a sender, a download manager (103) responsible for execution of a download operation upon receiving a request, and a communications manager (101) responsible for maintaining bilateral communications between the network server (100) and a base unit (200) and is capable of generating an WAP PUSH message and sending it to a messenger (401) of the service provider;
a base unit (200), which has a network user interface (201) and an uplink driver (202), wherein the uplink driver (202) is responsible for network connection, and the network user interface (201) serves to maintain bilateral communications between the base unit (200) and the network server (100), while both programs are resident in the base unit (200); and
whereby a sender of an electronic file can add a personalized note to an WAP PUSH message and put an electronic file onto the network server (100) to cause the network server (100) to send out the WAP PUSH message containing the personalized note and the routing information leading to the network server (100) for downloading a selected electronic file;
a mobile unit (300), which has a mobile user interface (301) responsible for receiving an WAP PUSH message to be issued by the network server (100), wherein the WAP PUSH message contains a personalized note of the sender and routing information leading to the network server (100) where the selected electronic file is kept for downloading.

4. The system of transmitting electronic files over to a mobile phone as claimed in claim 3, wherein the downloading of the electronic file by mobile unit (300) is timely recorded by the download manager (103) of the network server (100), whereby the sender of electronic file over base unit (200) can check with the network server (100) to find out whether the selected electronic file has been retrieved by the receiver.

5. The system of transmitting electronic files over to a mobile phone as claimed in claim 3, wherein the three components of the network server (100): the user disk (102), the download manager (103), and a communications manager (101) are implemented as separate devices.

6. The system of transmitting electronic files over to a mobile phone as claimed in claim 3, wherein the three components of the network server (100): the user disk (102), the download manager (103), and a communications manager (101) are combined together to form one integrated server.

7. The system of transmitting electronic files over to a mobile phone as claimed in claim 3, wherein two resident programs are in the base unit (200): a network user interface (201) and an uplink driver (202) are each independent from the other.

8. The system of transmitting electronic files over to a mobile phone as claimed in claim 3, wherein two resident programs are in the base unit (200): a network user interface (201) and an uplink driver (202) are combined into one integrated software resident in the base unit (200).

9. The system of transmitting electronic files over to a mobile phone as claimed in claim 3, wherein the base unit (200) is a personal computer.

10. The system of transmitting electronic files over to a mobile phone as claimed in claim 3, wherein the base unit (200) is a personal digital assistant (PDA).
